(19) United States
(12) Patent Application Publication
(10) Pub. No.: US 2015/0106169 A1
(43) Pub. Date: Apr. 16, 2015

(54) Ballot Builder

(71) Applicant: Everyone Counts, Inc., San Diego, CA (US)

(72) Inventors: Roy Grossberg, San Diego, CA (US); Thomas Hartwell, San Diego, CA (US); Warren Scott, San Diego, CA (US)

(21) Appl. No.: 14/512,238

(22) Filed: Oct. 10, 2014

Related U.S. Application Data
(60) Provisional application No. 61/889,474, filed on Oct. 10, 2013.

(51) Int. Cl. G07C 13/00

(52) U.S. Cl. CPC G07C 13/00; G06Q 2230/00
USPC 705/12

(57) ABSTRACT

Methods and apparatus, including computer program products, are provided for ballot generation. Related systems, methods, and articles of manufacture are also disclosed.

### CROSS REFERENCE TO RELATED APPLICATION

This application claims the benefit of priority under 35 U.S.C. §119(e) of U.S. provisional patent application No. 61/889,474, entitled “Ballot Builder,” filed on Oct. 10, 2013. The contents of the above-identified application are incorporated herein by reference in their entirety.

### TECHNICAL FIELD

The subject matter described herein relates generally to data processing and, in particular, to electronic voting.

### BACKGROUND

Electronic voting refers to voting electronically. For example electronic voting may be used by voters to access a ballot via a processor, such as a personal computer. The ballot is presented electronically to allow a user to cast a vote, and then the cast ballot can be submitted electronically and/or printed and submitted with other cast ballots to determine the results of the vote. The electronic voting process can thus be used to efficiently vote for politicians, propositions, corporate board of directors, and any other measure/position. However, configuring an election can be complex. For example, each jurisdiction may have laws and/or rules dictating the voting and electronic voting processes including what information should be presented on a ballot, the format of the information, and other aspects related to the voting. As such, configuring electronic voting can be time consuming and require complex computer coding and/or configuration—thus being prone to error and delays.

### SUMMARY

In some example embodiments, there is provided a method for building ballots for electronic voting. The method may include generating a page including a ballot template; selecting at least one of a plurality of placeholders for placement within the ballot template; mapping at least one of a plurality of election data fields to the at least one placeholder positioned within the ballot template; assigning the ballot template to at least one election contest; and generating, for the election contest, a ballot based on the assigned ballot template.

Articles are also described that comprise a tangibly embodied computer-readable medium embodying instructions that, when performed, cause one or more machines (for example, computers, etc.) to result in operations described herein. Similarly, apparatus are also described that can include a processor and a memory coupled to the processor. The memory can include one or more programs that cause the processor to perform one or more of the operations described herein.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 illustrates an example of a block diagram of a system configured to build ballots, in accordance with some example embodiments;

FIG. 2 illustrates a process flow for building ballots, in accordance with some example embodiments;

FIGS. 3-8 depict examples of pages generated during the ballot building process, in accordance with some example embodiments;

FIG. 9 depict an example ballot generated in accordance with some example embodiments; and

FIG. 10 depicts a processor, in accordance with some example embodiments.

### DETAILED DESCRIPTION

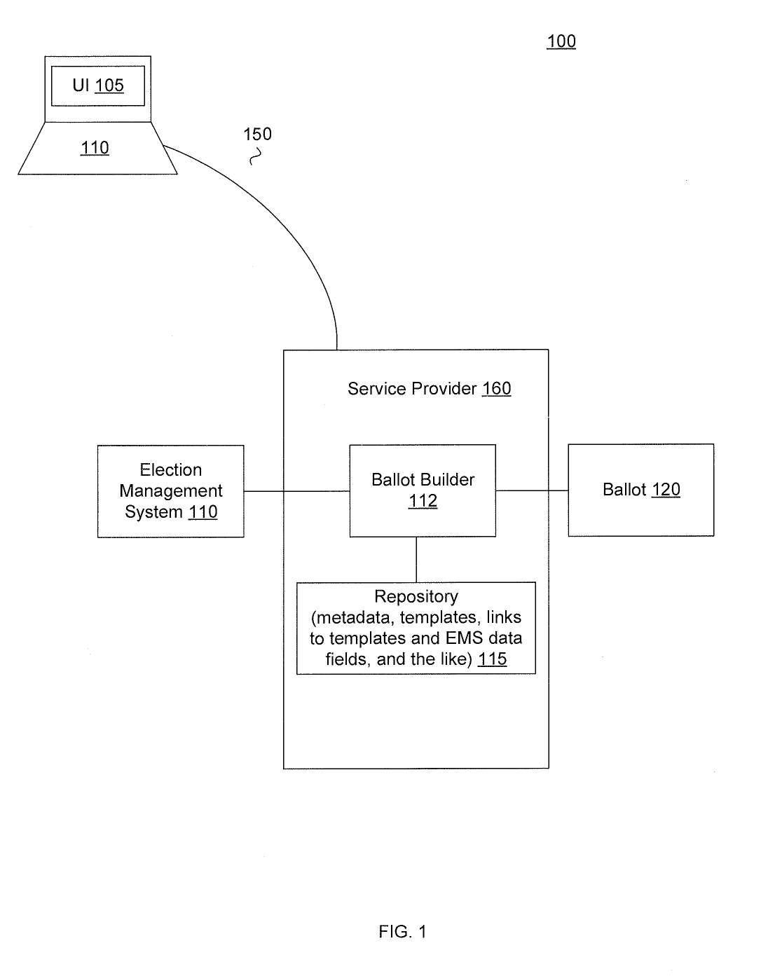

FIG. 1 depicts an example of a system 100 including a processor, such as computer 110 having a user interface 105 (for example, a browser, a client application, and/or the like). The computer 110 may be coupled via a network 150, such as the Internet, an intranet, and/or any other network or link, to a service provider 160. Service provider 160 may include a ballot builder 112 for programmatically building ballots. The service provider 160 may couple to an election management system 110 and a repository 115. In some example implementations, a user may access user interface 105 to access ballot builder 112, which configures and builds a ballot by mapping data fields of an election management system 110 to placeholders in a ballot template stored at repository 115.

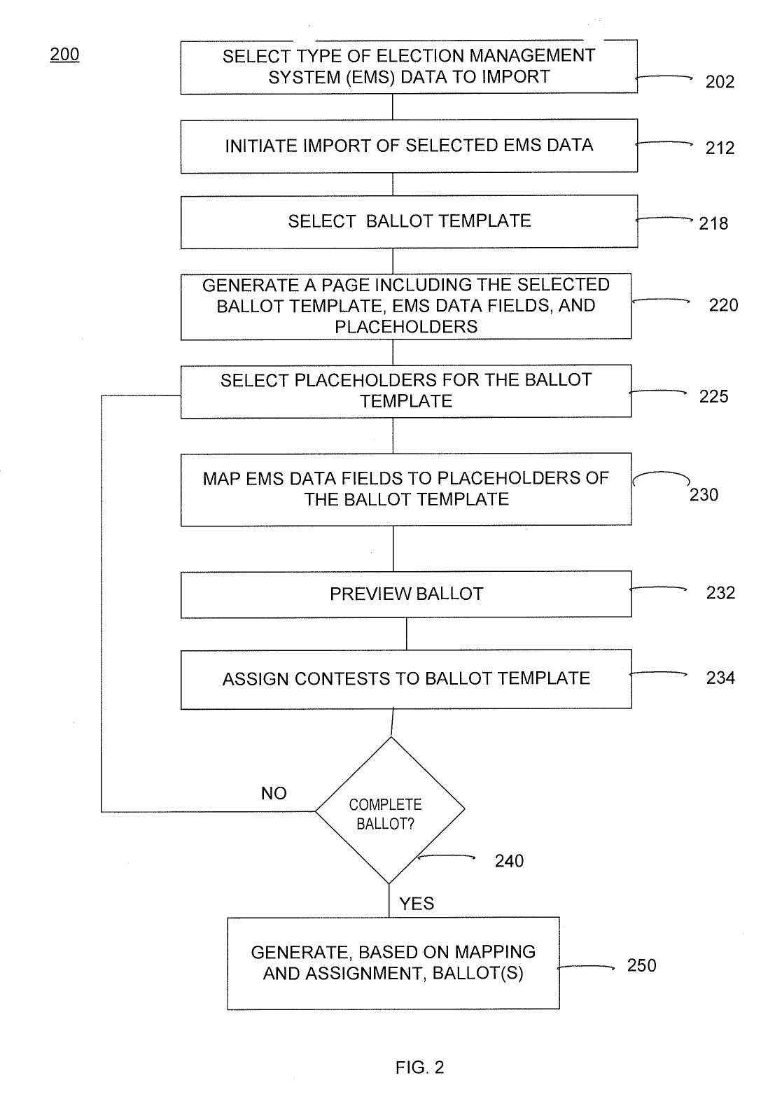

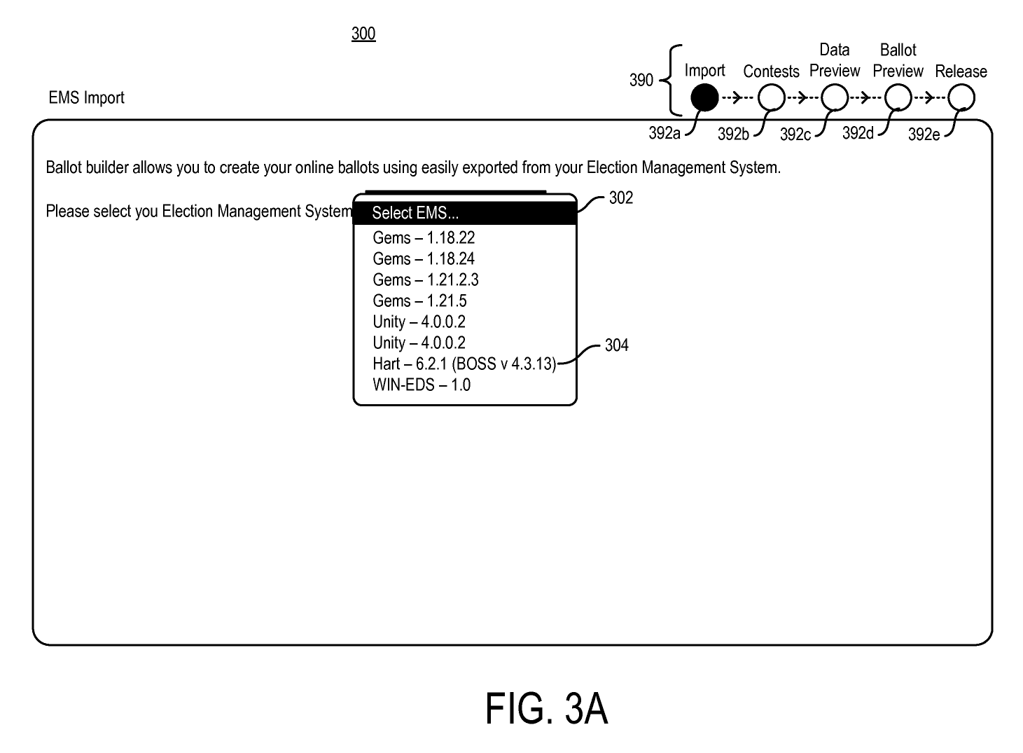

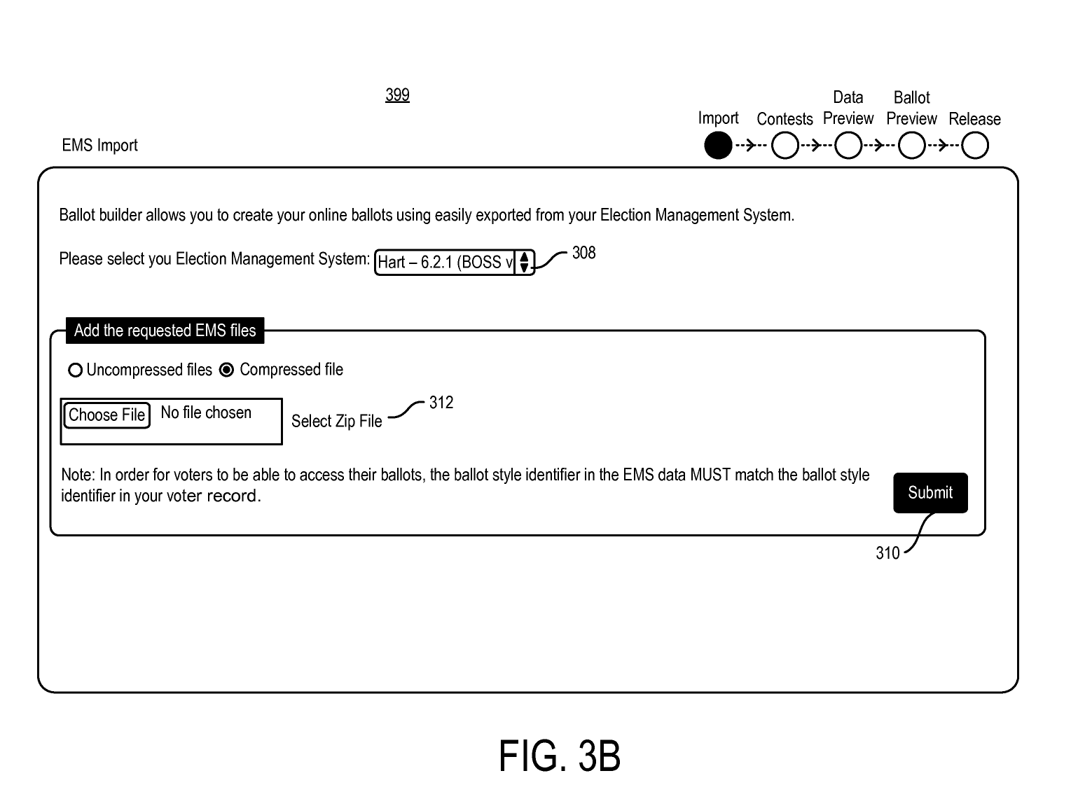

FIG. 2 depicts an example of a process for building ballots, in accordance with some example implementations. The description of FIG. 2 also refers to system 100 depicted at FIG. 1 and pages (or user interface views) depicted at FIGS. 3-9. A page may refer to a programmatically generated view or portion thereof (for example, a hypertext markup language document page) that can be presented on a user interface.

At 202, election management system data may be selected for importation into service provider 160. For example, a user interface 105 may access service provider 160 and receive a page 300 as depicted at FIG. 3A. At page 300, the user interface 105 may be used to select an election management system data 302 for importation into service provider 160.

In the example of FIG. 3A, the election management system data may be formatted in accordance with a plurality of proprietary election management system data formats (for example, Gems, Unity, Hart, Win-EDS, and the like), although non-proprietary formats may be selected as well. Without the service provider including ballot builder disclosed herein, a given jurisdiction may have to program code, use disparate complex election management systems, and the like in order to generate a ballot from these different election management systems. At 304, a Hart-type election management system data is selected, although other sources of EMS data systems may be selected as well.

FIG. 3A also depicts a ballot building process bar 390 that provides an indication of where page 300 is in the ballot building process. This bar 390 enables a user to visually determine what stage of the ballot building process is taking place at user interface 105. In some example implementations, bar 390 remains in the same or similar position on the pages used during the different stages of the ballot building process. In the instant example, the ballot building process bar 390 includes an import stage 392A (which is highlighted or otherwise graphically distinct from the stages of the ballot building process), a contest stage 392B corresponding to selecting contests, a data preview stage 392C where data being imported can be previewed, a ballot preview stage 392D where ballots can be previewed after mapping, and a release stage 392E where the completed ballot is released for use in election.

At 212, service provider 160 may receive the election management system data selection made at 212 and then initiate importation, from election management system 110, of the data selected at 202. The service provider 160 may include at repository 115 metadata describing the data format of the election management system data being imported. For example, this metadata may describe the fields used in the election management system data, so that the service provider can properly read the data in the election management system being imported given the data types, data structure (for example, specific content of columns and rows), and the like of the EMS data.

FIG. 3B depicts a page 399 which may be generated by service provider 160 including ballot builder 112 and presented at user interface 105. Page 399 shows election management system data selected at 202 (for example, a Hart type 308 of EMS data). Page 399 also shows that a user can initiate the import of election management system data by selecting submit 310. Page 399 shows that specific files 312 can be selected, such as by zip code, area, county, and the like, to enable ballot builder 112 to configure ballots on a per region, zip code, area, and the like basis. For example, an election official or other entity tasked with generating ballots may generate ballots from election management system data for each zip code holding an election.

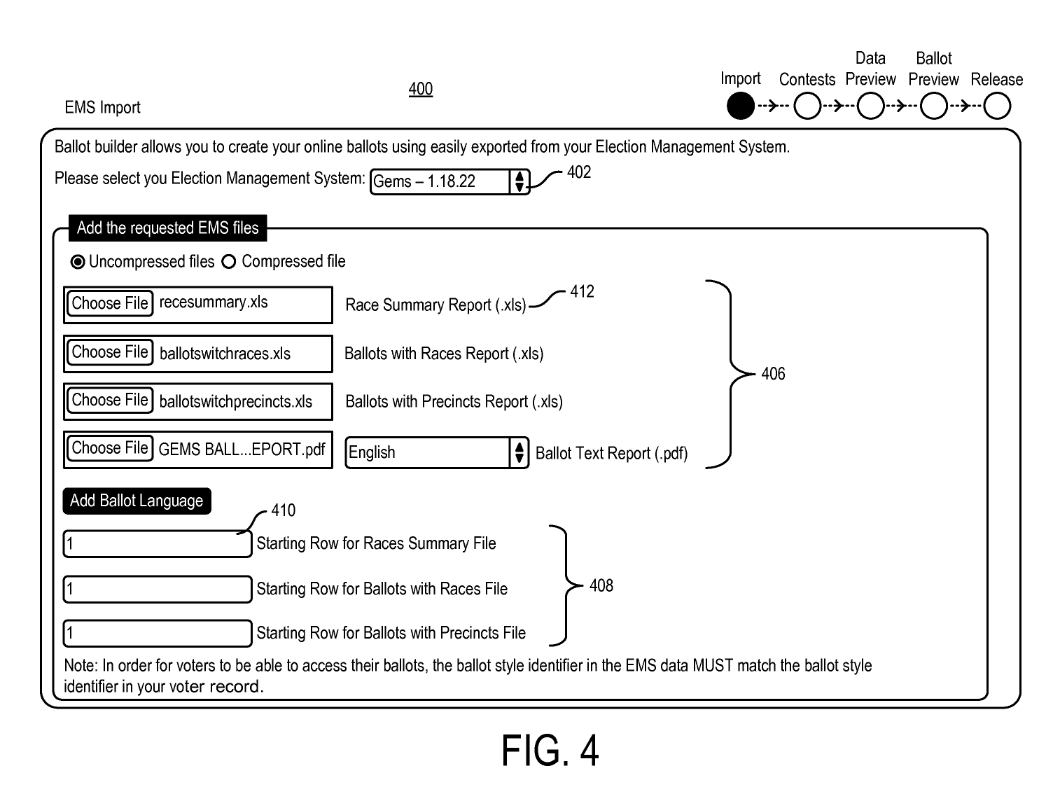

FIG. 4 depicts another example page 400. Page 400 is similar to page 300 in some respects but shows the selection of another type of election management system data, such as Gems type election management data. In the example of FIG. 4, four different election management system data files are selected 406 (Race Summary Report, Ballots with Races Report, Ballots with Precincts Report, and Ballot Text Report) and then retrieved by service provider 160 from EMS system 110 as part of the importation process.

FIG. 4 also allows selection of data at 408. For example, a race summary file may include metadata and other header information, which is not actual race related ballot information. As such, the starting row of the actual race data to be used by service provider 160 including ballot builder 112 can be identified at for example 410.

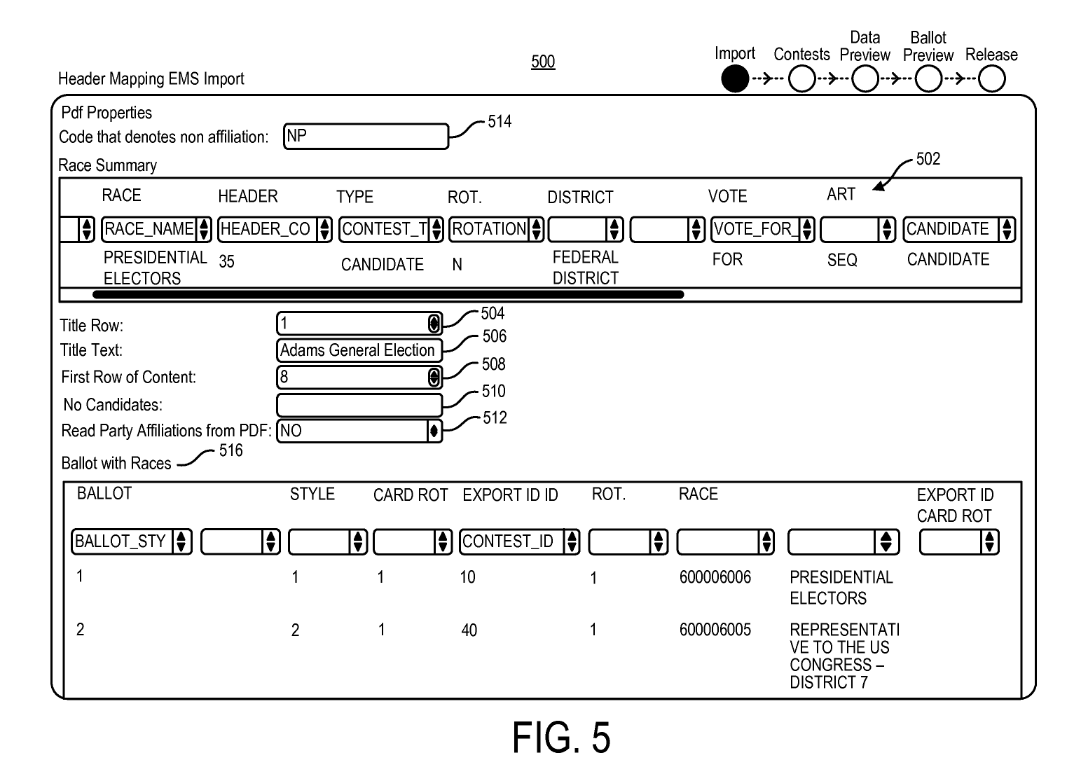

FIG. 5 depicts a page 500 generated by service provider 160 including ballot builder 112 and then sent to user interface 105 for presentation. Page 500 allows a selected EMS data file imported into service provider 160 (which may be stored on repository 115) to be further processed to allow previewing and/or modification of the EMS data file. For example, the Race Summary Report file 412 may be imported at 212, and this importation may be in accordance with metadata defining the format of file 412. Page 412 may also be used to preview and confirm that Race Summary Report file 412 was imported properly by viewing headers 502 describing the contents of the imported Race Summary Report file 412. Elements 504-516 describe aspects of the ballot.

At 218, a ballot template may be selected from repository 115, and a page may be generated at 220 including the selected ballot template. For example, repository 115 may include different templates for different types of elections, jurisdictions, and the like. Specifically, a ballot template may be defined for electing a candidate for federal office, another ballot template may be defined for a local ballot measure, and so forth. Moreover, a ballot template can be created and then saved at repository 115 for subsequent use.

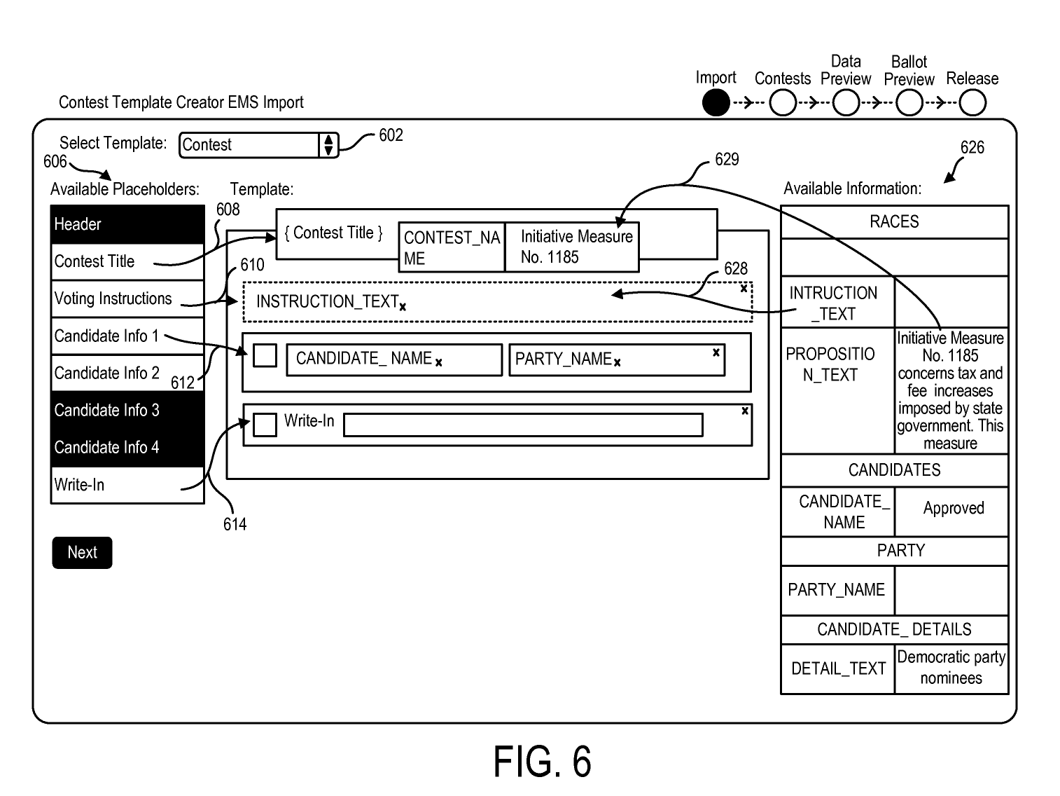

In the example of page 600 at FIG. 6, page 600 depicts a selection of a template named Contest 602 from one or more ballot templates stored at repository 115. If a certain template is not available in repository 115, the ballot template may be created via page 600 from scratch or via a modification to an existing ballot template. In any case, the ballot template may allow defining formats for the ballot and the content of the ballot, so that the overall appearance of the ballot can be defined via the ballot template.

In the example of page 600, placeholders 606 may be placed on the template 604 to define the form and format of the ballot. The contest title 608 may be selected and placed on template 604 at a certain location. The contest title 608 placeholder may define a location on a generated ballot and/or a data type (for example, a text type and/or a format for the text). The page 600 also includes placeholders for voting instructions 610, candidate information 612, write-ins 614, and the like. These placeholders may also be placed within template 604 at certain locations to define placement, content, format, and the like. In the example of FIG. 6, the placeholders have been predefined to allow selection and placement at 225.

The available information 626 represents EMS data (imported at 212) which can be mapped to placeholders at template 604. For example, instruction text data fields 626 can be mapped to placeholder 610 at template 604. The mapping may include selecting the instruction text 628, moving the selected instruction text 628 over the placeholder configured at template 604. And, dropping and dragging placeholder contest title at 608 as shown maps the contest title placeholder 608 to the proposition text data field 629, “Initiative Measure.” These mappings may also include storing, for each mapping, a link or a key value mapping the selected placeholder from 606 and the selected data field from 262 and storing the link/key. For example, during ballot generation the instructional text data field 628 imported from election management data is inserted, based on the mapping indicated by the link/key, into placeholder 610 and then formatted according to the placeholder 610. Although the previous example describes selection of certain placeholders and data fields, other placeholders and data fields may be selected as well.

At 225, a selection of placeholders may be made for the ballot template. As noted, selection of placeholders may be made via user interface 105. Specifically, user interface 105 including page 600 may be used to select placeholders and position those placeholders in template 604 being configured.

At 230, EMS data fields may be mapped to placeholders located on the ballot template. The EMS data fields at available information 626 may, as noted be dragged and dropped on to a placeholder in order to map the EMS data field to the placeholder. This dropping and dragging may thus map the EMS data field to the placeholder, although ways other than dropping and dragging may be used to associate the EMS data field and placeholder as well.

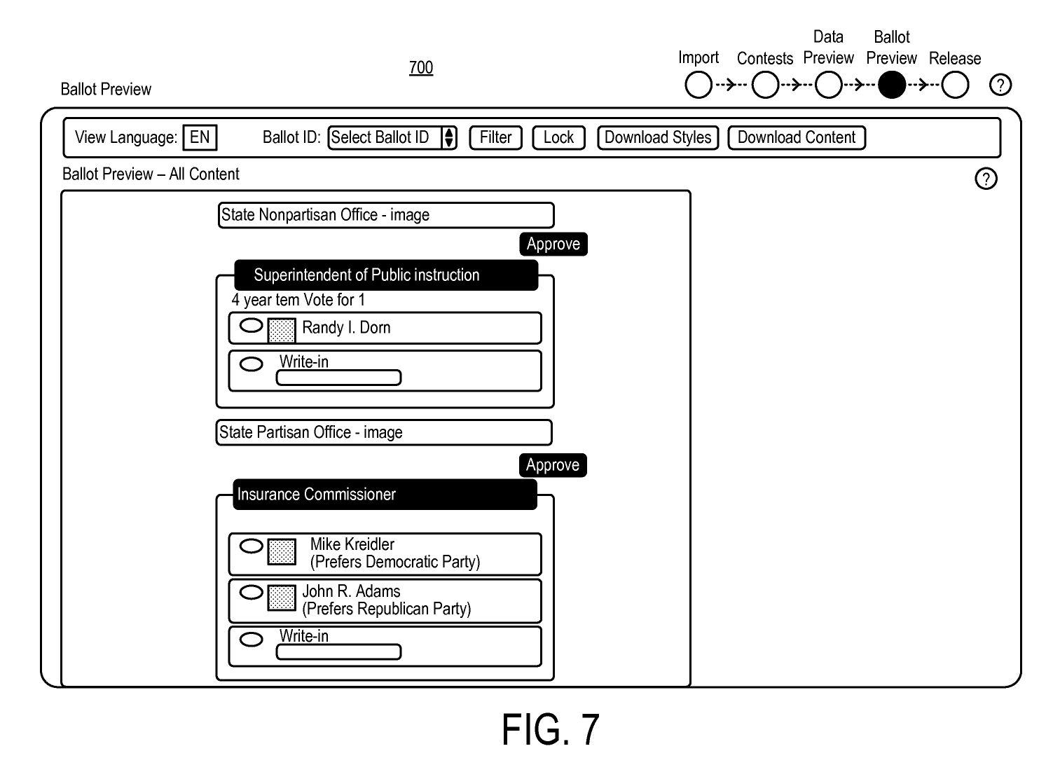

At 232, the mapped EMS data fields and placeholders may be previewed. FIG. 7 depicts an example page 700 including EMS data fields mapped to placeholders of a ballot, showing thus what a sample ballot would look like when generated.

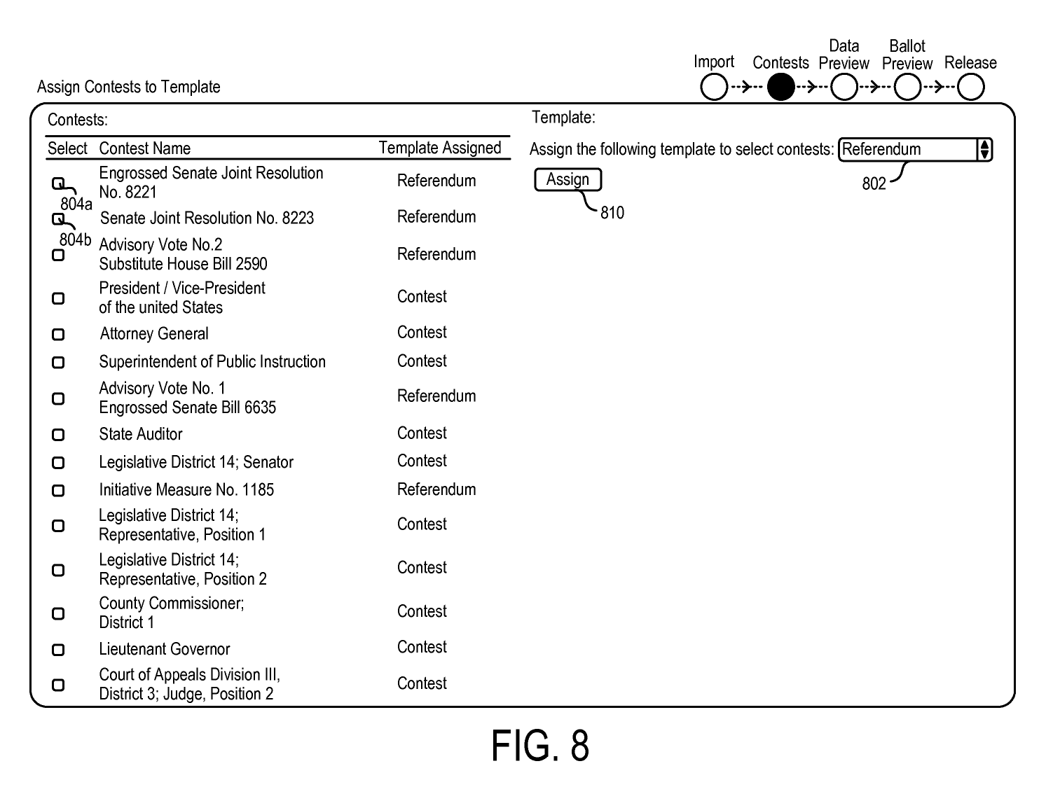

At 234, contests may be assigned to the ballot template, which includes mapped EMS data fields and placeholders. A given template may be used for a plurality of different contests. For example, a template may be defined as Gubernatorial template. This template may be assigned to a plurality of contests in different regions within for example within a state. FIG. 8 depicts page 800 which may be generated by service provider 160 including ballot builder 112 and presented at user interface 110. Page 800 may be used to initiate the contest assignments to templates. For example, the ballot template Referendum may be selected at 802 and then assigned 810 to one or more contests by for example selecting a contest at 804A, 804B, and so forth.

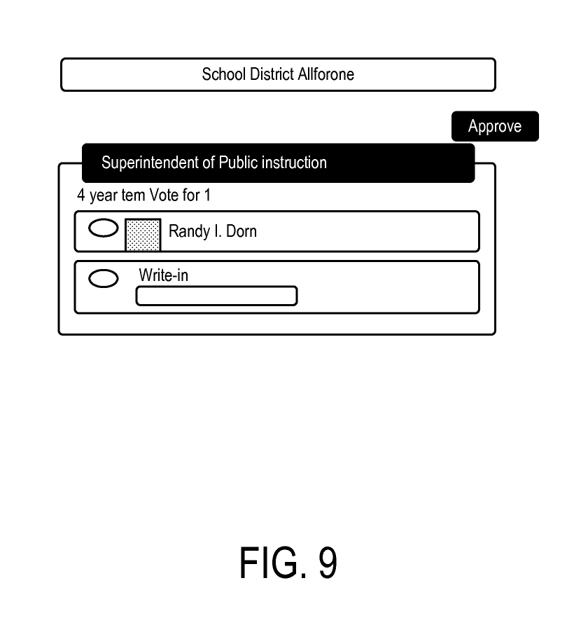

After one or more templates have been assigned to a contest, a ballot may be generated for the contest based on the mappings defined at 230 (yes at 240 and 250). For example, the ballot may be generated for a given contest and ballot template(s) assigned at 234 by inserting mapped EMS data fields of the ballot template into the placeholders. FIG. 9 depicts an example of a ballot 900 generated in accordance with process 200.

In some example implementations, process 200 may enable an entity to generate a variety of ballots without hardcoding or understanding the underlying metadata as the service provider handles importation, mapping, and the like for a variety of different types of EMS data. Moreover, service provider 160 may be implemented as a centralized service or cloud service (for example, software as a service). When this is the case, the service provider 160 can maintain accurate metadata for the EMS data types including revision thereto and offer a plurality of predetermined templates for use users.

In some example implementations, process 200 may enable an entity to generate a variety of ballots without hardcoding or understanding the underlying metadata as the service provider handles importation, mapping, and the like for a variety of different types of EMS data. Moreover, service provider 160 may be implemented as a centralized service or cloud service (for example, software as a service). When this is the case, the service provider 160 can maintain accurate metadata for the EMS data types including revision thereto and offer a plurality of predetermined templates for use users. In some example implementations, service provider 160 may be implemented as a software as a service provider, so execution of the ballot builder 112 is in the cloud (for example, a server at a website accessible and/or shared by other users).

Although FIG. 1 depicts a single computer 110, a single service provider 160, a single election management system 110, and a single ballot 120, other quantities and configurations of system 100 may be implemented as well.

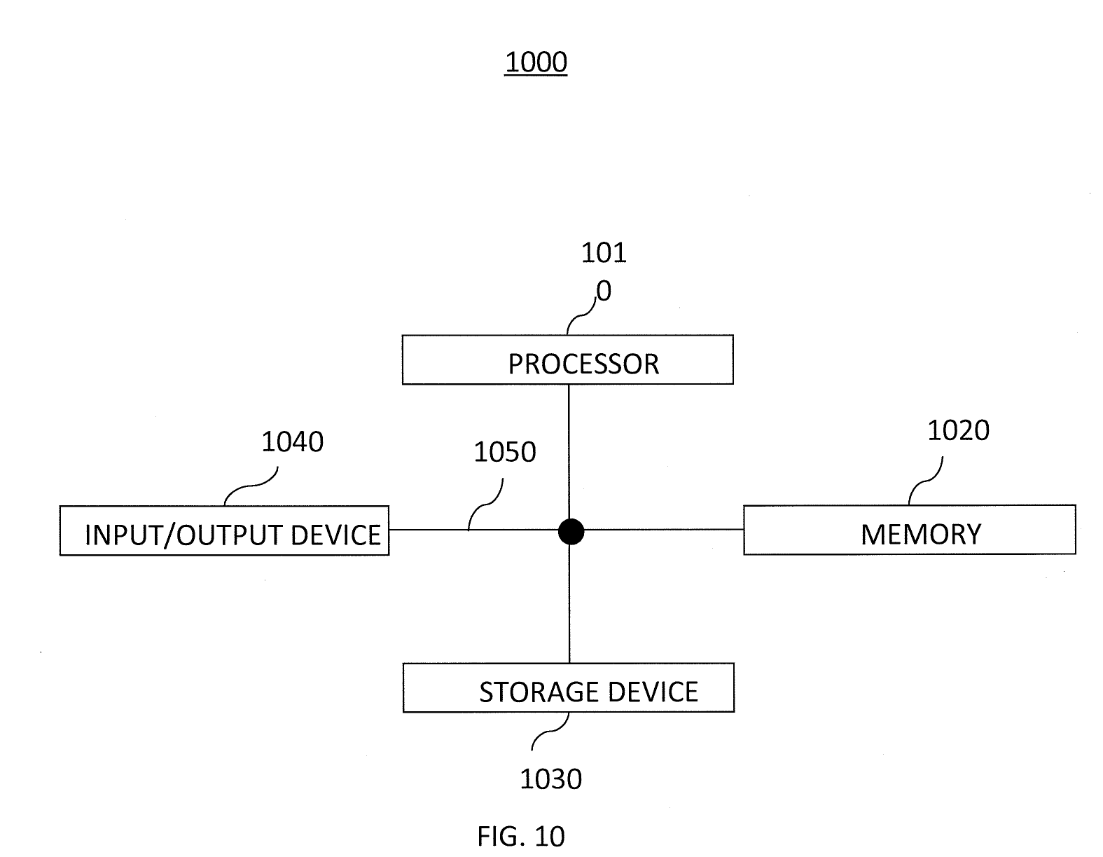

FIG. 10 depicts an example of a system, which can be used as the computer 110 or as a host for service provider 160. The system 1000 can include a processor 1010, a memory 1020, a storage device 1030, and an input/output device 1040. Each of the components 1010, 1020, 1030 and 1040 can be interconnected using a system bus 1050. The processor 1010 can be configured to process instructions for execution within the system 1000. In some implementations, the processor 1010 can be a single-threaded processor. In alternate implementations, the processor 1010 can be a multi-threaded processor. The processor 1010 can be further configured to process instructions stored in the memory 1020 or on the storage device 1030, including receiving or sending information through the input/output device 1040. The memory 1020 can store information within the system 1000. In some implementations, the memory 1020 can be a computer-readable medium. In alternate implementations, the memory 1020 can be a volatile memory unit. In yet some implementations, the memory 1020 can be a non-volatile memory unit. The storage device 1030 can be capable of providing mass storage for the system 1000. In some implementations, the storage device 1030 can be a computer-readable medium. In alternate implementations, the storage device 1030 can be a floppy disk device, a hard disk device, an optical disk device, a tape device, non-volatile solid-state memory, or any other type of storage device. The input/output device 1040 can be configured to provide input/output operations for the system 1000. In some implementations, the input/output device 1040 can include a keyboard and/or pointing device. In alternate implementations, the input/output device 1040 can include a display unit for displaying graphical user interfaces.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. As used herein, the term “user” can refer to any entity including a person or a computer. Other implementations may be within the scope of the following claims.

What is claimed:

1. A method comprising:
generating a page including a ballot template;
selecting at least one of a plurality of placeholders for placement within the ballot template;
mapping at least one of a plurality of election data fields to the at least one placeholder positioned within the ballot template;
assigning the ballot template to at least one election contest; and
generating, for the election contest, a ballot based on the assigned ballot template.

2. The method of claim 1 further comprising:
selecting a type of election management data.

3. The method of claim 1 further comprising:
importing the selected type of election management data.

4. The method of claim 1 further comprising:
generating a preview of the ballot based on the assigned ballot template.

5. The method of claim 1, wherein the page comprises electronic page.

6. The method of claim 1, wherein the ballot comprises electronic ballot.

7. An apparatus comprising:
at least one processor; and
at least one memory including computer program code, the at least one memory and the computer program code configured to, with the at least one processor, cause the apparatus to perform at least the following:
generate a page including a ballot template;
select at least one of a plurality of placeholders for placement within the ballot template;
map at least one of a plurality of election data fields to the at least one placeholder positioned within the ballot template;
assign the ballot template to at least one election contest; and
generate, for the election contest, a ballot based on the assigned ballot template.

8. The apparatus of claim 7, wherein the apparatus is further configured to at least select a type of election management data.

9. The apparatus of claim 7, wherein the apparatus is further configured to at least import the selected type of election management data.

10. The apparatus of claim 7, wherein the apparatus is further configured to at least generate a preview of the ballot based on the assigned ballot template.

11. The apparatus of claim 7, wherein the page comprises electronic page.

12. The apparatus of claim 7, wherein the ballot comprises electronic ballot.

13. A non-transitory computer-readable medium including program code which when executed by at least one process causes operations comprising:
generating a page including a ballot template;
selecting at least one of a plurality of placeholders for placement within the ballot template;
mapping at least one of a plurality of election data fields to the at least one placeholder positioned within the ballot template;
assigning the ballot template to at least one election contest; and
generating, for the election contest, a ballot based on the assigned ballot template.

14. The non-transitory computer-readable medium of claim 13 further comprising:
selecting a type of election management data.

15. The non-transitory computer-readable medium of claim 13 further comprising:
importing the selected type of election management data.

16. The non-transitory computer-readable medium of claim 13 further comprising:
generating a preview of the ballot based on the assigned ballot template.

17. The non-transitory computer-readable medium of claim 13, wherein the page comprises electronic page.

18. The non-transitory computer-readable medium of claim 13, wherein the ballot comprises electronic ballot.
